(19) United States
(12) Patent Application Publication
(10) Pub. No.: US 2021/0287330 A1
(43) Pub. Date: Sep. 16, 2021

(54) INFORMATION PROCESSING SYSTEM, METHOD OF INFORMATION PROCESSING, AND PROGRAM

(71) Applicant: SONY CORPORATION, Tokyo (JP)

(72) Inventors: Kae NAGANO, Tokyo (JP); Tetsuo IKEDA, Tokyo (JP)

(73) Assignee: SONY CORPORATION, Tokyo (JP)

(21) Appl. No.: 16/319,653

(22) PCT Filed: Jul. 24, 2017
(86) PCT No.: PCT/JP2017/026738

§ 371 Date: Jan. 22, 2019

(30) Foreign Application Priority Data
Aug. 31, 2016 (JP) 2016-168774

(51) Int. Cl. G06T 3/00; G06K 9/00; G06T 19/20; G06T 7/593; G06F 3/041; G06T 19/00

(52) U.S. Cl. CPC G06T 3/005; G06K 9/00637; G06K 9/00208; G06T 19/20; G06F 2203/04108; G06F 3/041; G06T 19/006; G06T 2219/2016; G06T 2200/24; G06T 7/593

(57) ABSTRACT

There is provided an information processing apparatus including: circuitry configured to detect a three-dimensional (3D) object and a distance from a surface of the 3D object to a reference position, wherein the surface of the 3D object is located between the reference position and a sensor that is used to detect the distance, determine an image corresponding to the detected 3D object and the detected distance from the surface of the 3D object to the reference position, and control a displaying of the determined image upon the surface of the 3D object.

### CROSS REFERENCE TO RELATED APPLICATIONS

This application claims the benefit of Japanese Priority Patent Application JP 2016-168774 filed Aug. 31, 2016, the entire contents of which are incorporated herein by reference.

### TECHNICAL FIELD

The present disclosure relates to an information processing system, a method of information processing, and a program.

### BACKGROUND ART

In related art, various techniques for displaying an image using a display device, for example, projectors and liquid crystal display (LCD) devices have been developed.

In one example, PTL 1 discloses a technique in which a portable terminal receives image data registered, in association with information on a detected current position, in a server and displays the image data on a display unit.

### CITATION LIST

### Patent Literature

### [PTL 1]

### JP 2006-048672A

### SUMMARY

### Technical Problem

However, in the technique disclosed in PTL 1, the image data to be displayed is determined only by information on the absolute position of the portable terminal.

Thus, the present disclosure provides a novel and improved information processing system, method of information processing, and program, capable of determining an image to be displayed adaptively to a positional relationship between a real object and a reference position.

### Solution to Problem

According to an embodiment of the present disclosure, there is provided an information processing apparatus including: circuitry configured to detect a three-dimensional (3D) object and a distance from a surface of the 3D object to a reference position, wherein the surface of the 3D object is located between the reference position and a sensor that is used to detect the distance, determine an image corresponding to the detected 3D object and the detected distance from the surface of the 3D object to the reference position, and control a displaying of the determined image upon the surface of the 3D object.

According to an embodiment of the present disclosure, there is provided an image processing method, performed via at least one processor, the method including: detecting a three-dimensional (3D) object and a distance from a surface of the 3D object to a reference position, wherein the surface of the 3D object is located between the reference position and a sensor that is used to detect the distance, determining an image corresponding to the detected 3D object and the detected distance from the surface of the 3D object to the reference position, and controlling a displaying of the determined image upon the surface of the 3D object.

According to an embodiment of the present disclosure, there is provided a non-transitory computer-readable medium having embodied thereon a program, which when executed by a computer, causes the computer to execute a method, the method including: detecting a three-dimensional (3D) object and a distance from a surface of the 3D object to a reference position, wherein the surface of the 3D object is located between the reference position and a sensor that is used to detect the distance, determining an image corresponding to the detected 3D object and the detected distance from the surface of the 3D object to the reference position, and controlling a displaying of the determined image upon the surface of the 3D object.

### Advantageous Effects of Invention

According to the present disclosure described above, it is possible to determine the image to be displayed adaptively to the positional relationship between the real object and the reference position. Moreover, the effects described herein are not necessarily limited, and any of the effects described in the present disclosure may be applied.

### BRIEF DESCRIPTION OF DRAWINGS

FIG. 1 is a diagram illustrated to describe a configuration example of an information processing system according to an embodiment of the present disclosure.

FIG. 2 is a diagram illustrated to describe an example in which an information processing device 10 according to an embodiment projects an image in a direction parallel to a placement surface 30.

FIG. 3 is a functional block diagram illustrating a configuration example of the information processing device 10 according to an embodiment.

FIG. 4 is a diagram illustrated to describe an example of the association between a height from a reference position and data 40 of each of a plurality of hierarchies, according to an embodiment.

FIG. 5 is a diagram illustrated to describe an example of the association between stacked plate 32 arranged horizontally and volume data 42, according to an embodiment.

FIG. 6 is a diagram illustrated to describe an example of the association between stacked plate 32 arranged obliquely and the volume data 42, according to an embodiment.

FIG. 7 is a diagram illustrated to describe an example of the association between the stacked plate 32 having the same shape as a product 44 and data of the internal structure of the product 44.

FIG. 8A is a diagram illustrating an example in which a real object is not placed on the placement surface 30.

FIG. 8B is a diagram illustrating an example of an image to be displayed that is determined by the information processing device 10 in the situation shown in FIG. 8A.

FIG. 9A is a diagram illustrating a state in which the stacked plate 32 is placed on the placement surface 30 after the situation shown in FIG. 8A.

FIG. 9B is a diagram illustrating an example of an image to be displayed that is determined by the information processing device 10 in the situation shown in FIG. 9A.

FIG. 10A is a diagram illustrated to describe a state in which the uppermost plate of the stacked plate 32 is removed after the situation shown in FIG. 9A.

FIG. 10B is a diagram illustrating an example of an image to be displayed that is determined by the information processing device 10 in the situation shown in FIG. 10A.

FIG. 11A is a diagram illustrated to describe a state in which the uppermost plate of the stacked plate 32 is removed after the situation shown in FIG. 10A.

FIG. 11B is a diagram illustrating an example of an image to be displayed that is determined by the information processing device 10 in the situation shown in FIG. 11A.

FIG. 12A is a diagram illustrating the stacked plate 32 arranged on the placement surface 30.

FIG. 12B is a diagram illustrating a display example of an image showing an air flow simulation inside a hierarchy corresponding to the height of the stacked plate 32 from the placement surface 30 in the situation shown in FIG. 12A.

FIG. 13 is a diagram illustrating an example of stacked plate 32 in which the top surface of the uppermost plate is a slope.

FIG. 14A is a diagram illustrating an example of a positional relationship between the stacked plate 32 and the user.

FIG. 14B is a diagram illustrating an example of an image to be displayed that is corrected depending on the positional relationship between the stacked plate 32 and the user in the situation shown in FIG. 14A.

FIG. 15 is a diagram illustrated to describe an example in which an image to be displayed is corrected depending on the position of a virtual light source arranged in a 3D scene.

FIG. 16 is a diagram illustrated to describe another example in which an image to be displayed is corrected depending on the position of a virtual light source arranged in a 3D scene.

FIG. 17 is a diagram illustrated to describe an example in which the size of a UI object 50 to be projected is corrected depending on the height of the surface on which the UI object 50 is projected from the placement surface 30.

FIG. 18 is a diagram illustrated to describe an example of a GUI 50 used to change settings of the correspondence relationship between the stacked plate 32 and digital data.

FIG. 19 is a diagram illustrated to describe an example of the scale reduction of a range corresponding to one plate with respect to the height direction of volume data 42.

FIG. 20 is a flowchart illustrating one part of the processing procedure according to an application example 1 of an embodiment.

FIG. 21 is a flowchart illustrating the other part of the processing procedure according to an application example 1 of an embodiment.

FIG. 22 is a diagram illustrating a display example of an icon 60 indicating the presence of a UI object 52 in a case where a user brings his/her hand close to the top surface of the stacked plate 32.

FIG. 23 is a diagram illustrating an example in which the display position of a UI object 52 is moved on the basis of a touch operation on the top surface of the stacked plate 32.

FIG. 24A is a diagram illustrating an example in which a UI object 52 to be selected by a user is specified in a case where the touch position on the top surface of the plate is 70a.

FIG. 24B is a diagram illustrating an example in which a UI object 52 to be selected by a user is specified in a case where the touch position on the top surface of the plate is 70b.

FIG. 25A is a diagram illustrating an example in which a UI object 52 to be selected by a user is specified in a case where the distance between the top surface of the plate and the hand is La.

FIG. 25B is a diagram illustrating an example in which a UI object 52 to be selected by a user is specified in a case where the distance between the top surface of the plate and the hand is Lb.

FIG. 26 is a flowchart illustrating one part of the processing procedure according to application example 2 of an embodiment.

FIG. 27 is a flowchart illustrating the other part of the processing procedure according to application example 2 of an embodiment.

FIG. 28 is a diagram illustrating an example of the association between data of each of a plurality of hierarchies and individual plates.

FIG. 29 is a diagram illustrating an example in which an image is projected on each of the plates arranged side by side on the placement surface 30.

FIG. 30 is a diagram illustrated to describe an example of the hardware configuration of the information processing device 10 according to an embodiment.

FIG. 31 is a diagram illustrating an example of a gesture operation for changing the scale of a range corresponding to one plate with respect to the height direction of the volume data 42.

### DESCRIPTION OF EMBODIMENTS

Hereinafter, an embodiment of the present disclosure will be described in detail with reference to the appended drawings. In this specification and the appended drawings, components that have substantially the same function and structure are denoted with the same reference numerals, and repeated description of these components is omitted.

In addition, there are cases in the present specification and the diagrams in which a plurality of components having substantially the same functional configuration are distinguished from each other by affixing different letters to the same reference numbers. In one example, a plurality of components having substantially identical functional configuration are distinguished, like information processing devices 10a and 10b, if necessary. However, when there is no particular need to distinguish a plurality of components having substantially the same functional configuration from each other, only the same reference number is affixed thereto. In one example, when there is no particular need to distinguish information processing devices 10a and 10b, they are referred to simply as an information processing device 10.

Further, the “modes for carrying out the disclosure” is described in accordance with the order of items listed below.

1. Configuration of information processing system
2. Detailed description of embodiment
3. Hardware configuration
4. Modified example

### 1. CONFIGURATION OF INFORMATION PROCESSING SYSTEM

### 1-1. Basic Configuration

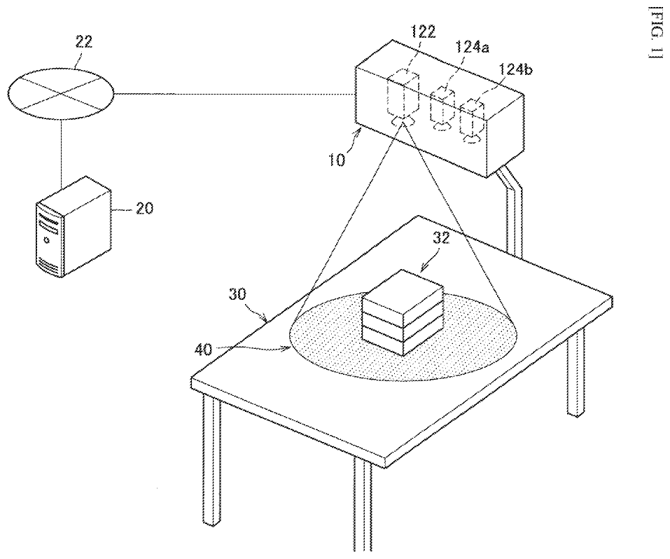

An exemplary configuration of an information processing system according to an embodiment of the present disclosure is first described with reference to FIG. 1. As illustrated in FIG. 1, the information processing system according to an embodiment has an information processing device 10, a server 20, and a communication network 22.

### 1-1-1. Information Processing Device 10

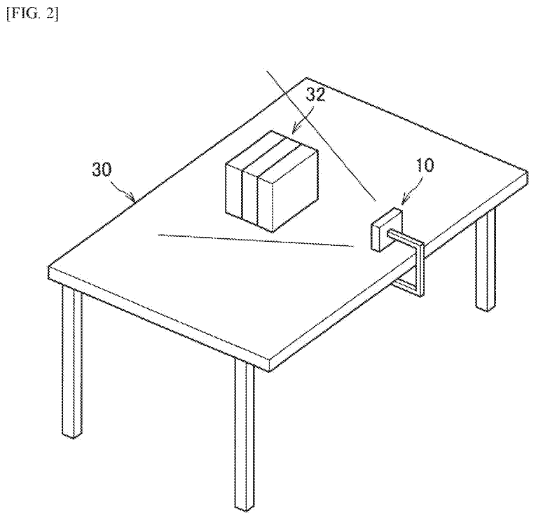

The information processing device 10 is a device that determines an image to be displayed in association with a real object on the basis of a recognition result obtained by recognizing the real object. In one example, the information processing device 10 determines an image to be displayed in association with the real object on the basis of digital data corresponding to the recognized real object. Here, the real object may be, for example, (physical) stacked plates 32 in which one or more plates are arranged on top of each other as illustrated in FIG. 1. Moreover, as illustrated in FIG. 1, the stacked plate 32 may be arranged on a placement surface 30, for example, the top surface of a table in a real space. Alternatively, as illustrated in FIG. 2, the individual plates may be arranged side by side in a direction parallel to the placement surface 30. A projector for projecting an image onto the plates may be located to a side of a side surface of the plates arranged side by side.

Further, the digital data may be, for example, volume data, a plurality of two-dimensional data sets (e.g., 2D computer graphic (CG) data or still image), a moving image, or real-time rendering data. Moreover, the volume data is basically three-dimensional data and may include data inside the outer peripheral surface. The digital data may be, for example, 3D CG modeling data, medical data such as computed tomography (CT) image and magnetic resonance imaging (MRI) image, environmental data such as temperature distribution, or fluid simulation data.

In one example, as illustrated in FIG. 1, the information processing device 10 may be a projector device including a display unit 122 and a sensor unit 124. In addition, as illustrated in FIG. 1, the information processing device 10 may be arranged above the placement surface 30. Here, a reference position used in the present disclosure may be the position of the placement surface 30, or alternatively, the position of the sensor unit 124.

### 1-1-1-1. Display Unit 122

The display unit 122 may be, for example, a projector (projection unit). In one example, the display unit 122 projects an image to be displayed in the direction of the placement surface 30. Alternatively, as illustrated in FIG. 2, the display unit 122 may project an image to be displayed in a direction parallel to the top surface 30 of the table, or may project the image in a direction oblique to the top surface. Moreover, the image to be displayed may be stored in the information processing device 10 or may be received from the server 20 described later.

### 1-1-1-2. Sensor Unit 124

The sensor unit 124 may include an RGB camera (hereinafter referred to as a camera) 124a, a depth sensor 124b, and the like. The sensor unit 124 detects information on a space in front of the sensor unit 124. In one example, the sensor unit 124 captures an image in front of the sensor unit 124 or detects a distance to a real object located in front of the sensor unit 124. Moreover, the sensor unit 124 may include a stereo camera instead of, or in addition to, the depth sensor 124b. In this case, the stereo camera can detect the distance to the real object located in front of the stereo camera.

In one example, as illustrated in FIG. 1, in the case where the information processing device 10 is arranged above the placement surface 30, the camera 124a captures images of the placement surface 30 and the stacked plate 32. In addition, the depth sensor 124b detects the distance from the depth sensor 124b to the placement surface 30 or the stacked plate 32.

Further, the information processing device 10 can transmit and receive information to and from the server 20. In one example, the information processing device 10 transmits a request to acquire an image to be displayed or digital data to the server 20 via the communication network 22 described later.

### 1-1-2. Server 20

The server 20 is a device for storing various images and various types of digital data. In addition, the server 20, when receiving the request to acquire an image or digital data from the information processing device 10, transmits the requested image or digital data to the information processing device 10.

### 1-1-3. Communication Network 22

The communication network 22 is a wired or wireless transmission channel for information transmitted from a device connected to the communication network 22. An example of the communication network 22 may include a public line network such as telephone network, the Internet, and satellite communication network, various local area network (LAN) including Ethernet (registered trademark), a wide area network (WAN). In addition, an example of the communication network 22 may include a leased line network such as internet protocol-virtual private network (IP-VPN).

### 1-2. Summary of Challenges

The configuration of the information processing system according to embodiments have been described above. In the field of architectural design or product design, an architectural model view or product model view showing a vertical or horizontal cross section has been produced using 3D CG to show the interior of the architectural structure or the internal structure of the product to a person concerned. However, it is difficult to perform imaging of the actual shape only with the 3D CG screen. Thus, in many cases, a separate building model or product mock-up is produced, and in this event, it is necessary for the user to check the 3D CG screen and the model individually, which is inconvenient for the user.

Further, it is preferable that multiple persons can simultaneously check the interior of the architectural structure or the internal structure of the product.

Thus, the information processing device 10 according to an embodiment is made in view of the above circumstances as one focus point. The information processing device 10 can determine an image to be displayed in association with a surface included in a real object (hereinafter referred to simply as an image to be displayed) by the display unit 122. This determination is based on a recognition result obtained by recognizing a positional relationship between a surface included in a real object and a reference position, and is based on digital data corresponding to the real object. Thus, in one example, the user can perform an interactive change of an image projected on a plate by stacking or removing a plate on the placement surface 30.

### 2. DETAILED DESCRIPTION OF EMBODIMENT

### 2-1. Configuration

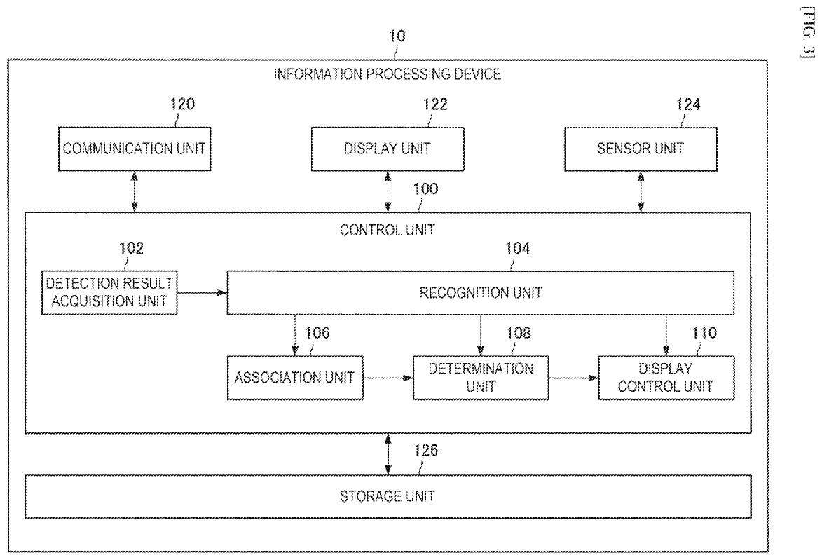

Next, the configuration of the information processing device 10 according to an embodiment is described in detail. FIG. 3 is a functional block diagram illustrating the configuration of the information processing device 10 according to an embodiment. As illustrated in FIG. 3, the information processing device 10 is configured to include a control unit 100, a communication unit 120, a display unit 122, a sensor unit 124, and a storage unit 126.

### 2-1-1. Control Unit 100

The control unit 100 controls the overall operations of the information processing device 10 using hardware including, for example, a central processing unit (CPU) 150, and a random access memory (RAM) 154, built in the information processing device 10. Such hardware will be described later. In addition, as illustrated in FIG. 3, the control unit 100 is configured to include a detection result acquisition unit 102, a recognition unit 104, an association unit 106, a determination unit 108, and a display control unit 110.

### 2-1-2. Detection Result Acquisition Unit 102

The detection result acquisition unit 102 acquires a result obtained by the sensor unit 124. In one example, the detection result acquisition unit 102 receives, as sensor data, a captured image captured by the sensor unit 124 and distance information on a distance to the real object located in front of the sensor unit 124 and detected by the sensor unit 124, or acquires them by performing reading processing or the like.

### 2-1-3. Recognition Unit 104

The recognition unit 104 is an example of an acquisition unit in an embodiment of the present disclosure. The recognition unit 104 recognizes at least one of the position, posture, shape, material, and type of a real object detected by the sensor unit 124, on the basis of a detection result acquired by the detection result acquisition unit 102. In one example, the recognition unit 104 recognizes the position, posture, shape, material, and type of a real object, on the basis of the captured image acquired by the detection result acquisition unit 102. In addition, the recognition unit 104 recognizes a positional relationship between the real object and the reference position on the basis of the acquired distance information. In one example, the recognition unit 104 recognizes the height of the stacked plate 32 by comparing the distance information indicating a distance to the detected placement surface 30 with distance information indicating a distance to the detected stacked plate 32.

Further, in the case where the hand of a user is captured, the recognition unit 104 recognizes the movement of the user's hand on the basis of the acquired captured image. In one example, the recognition unit 104 recognizes the movement of the user's hand with respect to the placement surface 30 or the stacked plate 32.

### 2-1-4. Association Unit 106

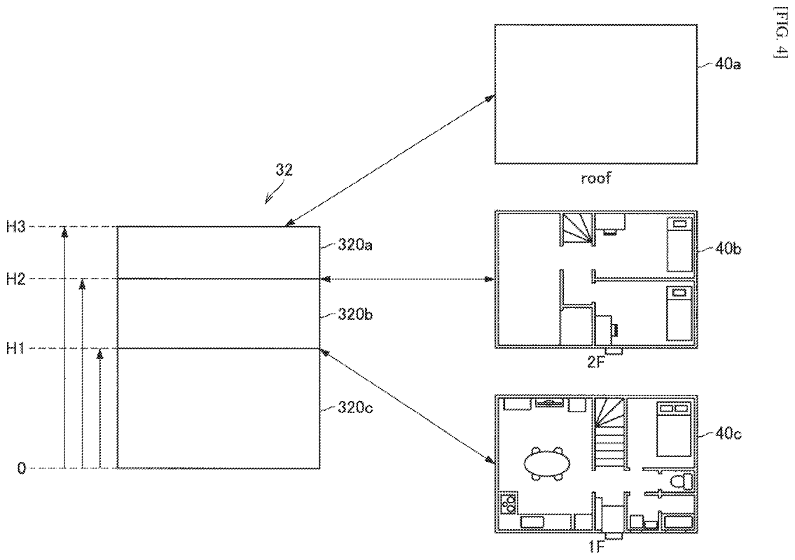

The association unit 106 associates the positional relationship between the reference position and the real object with the digital data, for example, in advance. In one example, the association unit 106 associates the height of the real object (e.g., the stacked plate 32) from the placement surface 30 with the digital data. In one example, in the case where the digital data includes data 40 of a plurality of hierarchies (e.g., data of cross sections), as the height of the real object from the placement surface 30 is higher, the association unit 106 sets data 40 of a higher hierarchy as a target to be associated, as illustrated in FIG. 4. In the example illustrated in FIG. 4, the association unit 106 associates a case where the height of a real object from the placement surface 30 is within a predetermined threshold range from “H3” with digital data 40a of the “roof” of a building. In addition, the association unit 106 associates a case where the height of the real object from the placement surface 30 is within a predetermined threshold range from “H2” with digital data 40b of the “second floor” of the building. In addition, the association unit 106 associates a case where the height of the real object from the placement surface 30 is within a predetermined threshold range from “H1” with digital data 40c of the “first floor” of the building. Moreover, as illustrated in FIG. 4, the data 40 of each of the plurality of hierarchies may be basically an image obtained by capturing the hierarchy from directly above in a virtual space, for example.

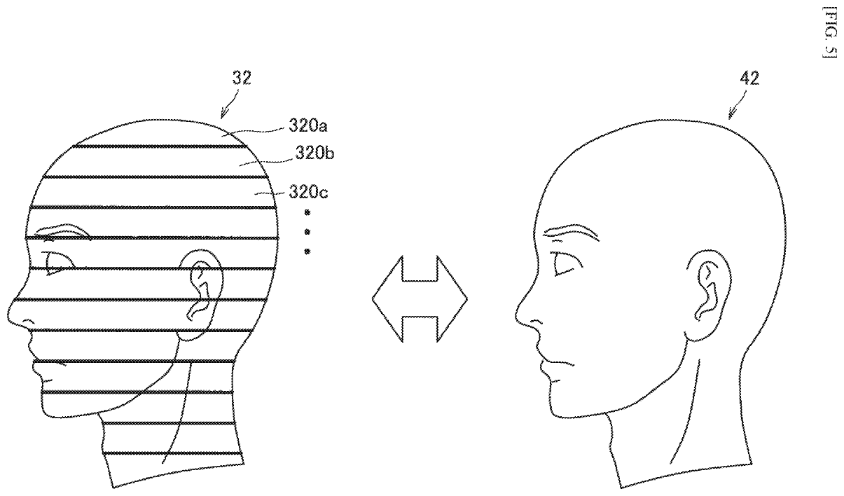

Further, as illustrated in FIG. 5, in the case where the digital data is, for example, volume data 42 such as CT of the head, the association unit 106 associates the volume data 42 with the all or some of the stacked plates 32 arranged on the placement surface 30. In one example, as illustrated in FIG. 5, the association unit 106 associates all the stacked plates 32 formed to be similar to the volume data 42 with the entire volume data 42.

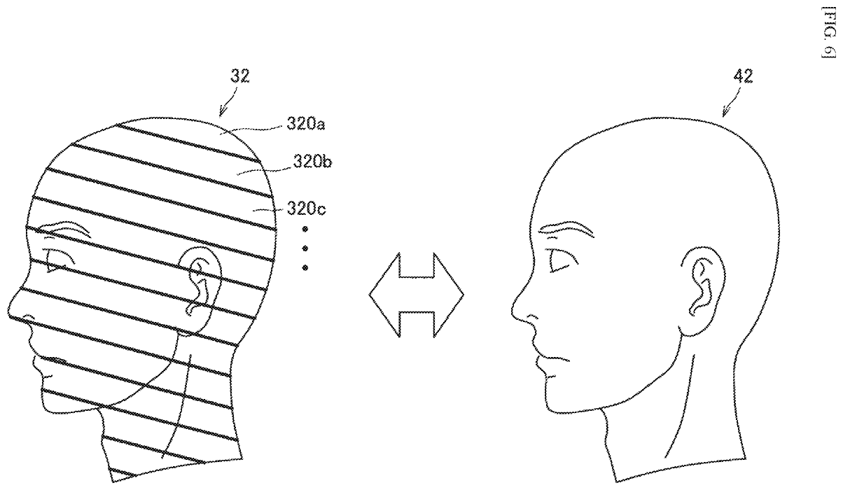

Moreover, as illustrated in FIG. 5, the stacked plate is not limited to the example in which individual plates 320 are horizontally formed. In one example, as illustrated in FIG. 6, the individual plates 320 may be formed obliquely. According to this example, it is possible to display information on a cross section with the optimum angle depending on the use application. Moreover, in this case, in one example, the individual plates 320 may include a magnet, and the individual plates 320 may be arranged on top of each other via the magnet.

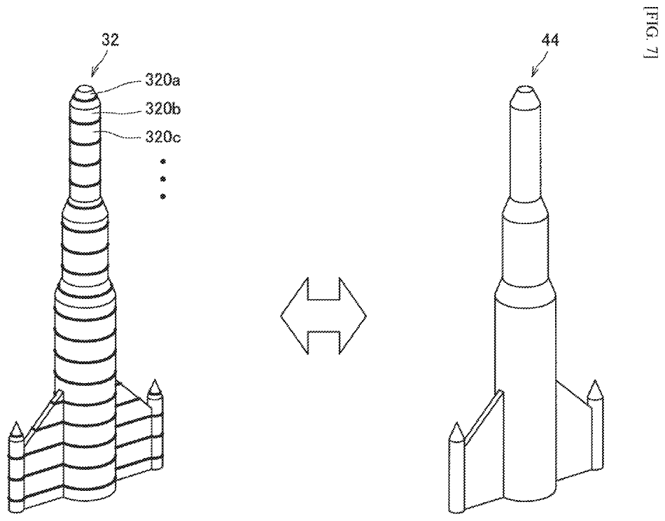

Further, as illustrated in FIG. 7, the association unit 106 associates the data of the internal structure of a product 44 with the stacked plate 32 formed, for example, with the same size as the product 44. According to this example, the internal structure corresponding to the height of the plate 320 arranged at the top can be projected on the plate 320 by the display unit 122. Thus, it is possible for the user to check easily the internal structure of the product 44 and the actual scale by removing or stacking the individual plates 320.

### 2-1-5. Determination Unit 108

### 2-1-5-1. Determination Example 1

The determination unit 108 determines an image to be displayed, on the basis of the positional relationship, recognized by the recognition unit 104, between the reference position and a surface having the minimum or maximum distance to the reference position among surfaces included in the real object and the digital data corresponding to the real object.

In one example, the determination unit 108 first specifies a real object on the basis of a recognition result obtained by recognizing the shape of the real object detected by the sensor unit 124. Next, the determination unit 108 acquires digital data corresponding to the specified real object, for example, from the storage unit 126 or the server 20. Then, the determination unit 108 determines an image to be displayed on the basis of a recognition result obtained by recognizing the height of the real object from the placement surface 30 and the acquired digital data.

In one example, there may be a case where the digital data corresponding to the stacked plate 32 includes the data 40 of the plurality of hierarchies, as in the example illustrated in FIG. 4. In this case, the determination unit 108 determines, as the image to be displayed, an image of the digital data 40 of the hierarchy corresponding to the height of the stacked plate 32 from the placement surface 30. In addition, in the case where the digital data is the volume data 42 as the examples illustrated in FIGS. 5 and 6, the determination unit 108 determines, as the image to be displayed, an image indicating a cross section of the volume data 42 corresponding to the height of the stacked plate 32 from the placement surface 30.

Further, in one example, there may be a case where it is recognized that a plate closest to the display unit 122 is changed, such as when the plate closest to the display unit 122 is removed or when another plate is further arranged on top of the plate. In this case, the determination unit 108 determines the image to be displayed on the basis of a recognition result obtained by recognizing the changed positional relationship between the plate closest to the display unit 122 and the placement surface 30.

### Specific Example

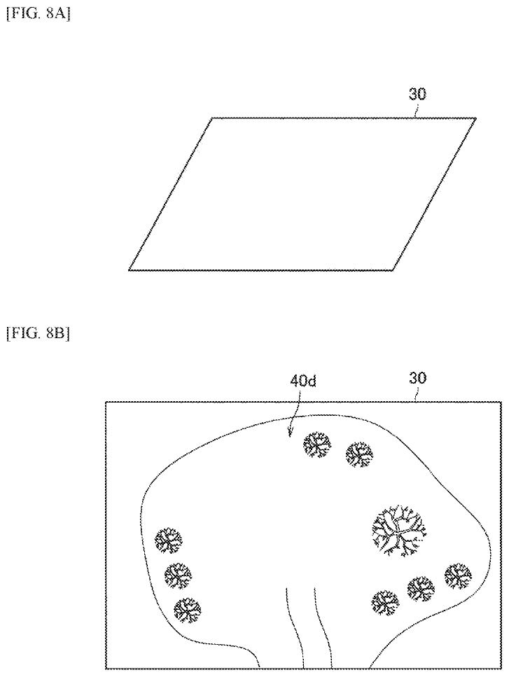

The above-described items will be described in more detail with reference to FIGS. 8A to 11B. Moreover, in the example illustrated in FIGS. 8A to 11B, the association between the height from the placement surface 30 and the data 40 of each of the plurality of hierarchies as illustrated in FIG. 4 is assumed to be performed in advance.

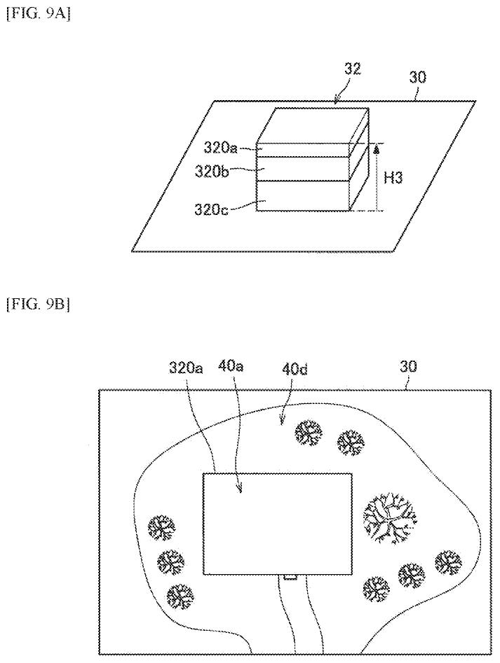

In the case where a real object is not placed on the placement surface 30 as illustrated in FIG. 8A, the determination unit 108 determines, as the image to be displayed, only an image 40d indicating a site, as illustrated in FIG. 8B. In addition, there may be a case where the stacked plates 32 (three plates are arranged on top of each other) for a house are placed on the placement surface 30 as illustrated in FIG. 9A. In this case, the determination unit 108 determines, as an image to be displayed on the stacked plates 32, an image of the digital data 40a of the “roof” associated with the height of the stacked plates 32 from the placement surface 30 (“H3” in the example illustrated in FIG. 9A), as illustrated in FIG. 9B. Similarly, the determination unit 108 determines an image 40d indicating the site as an image to be displayed in the area where the stacked plates 32 is not arranged on the placement surface 30.

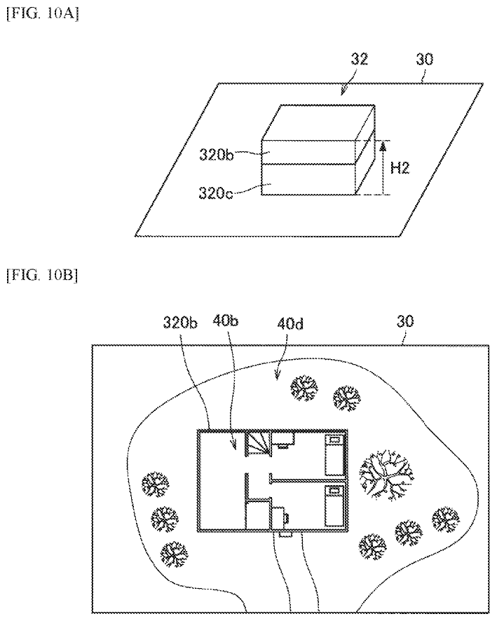

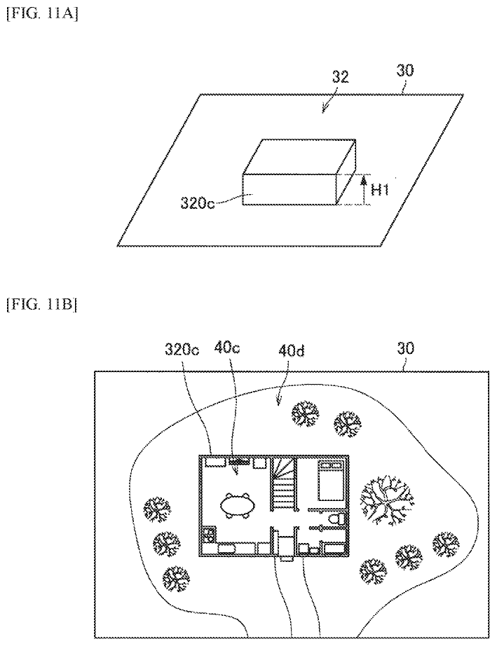

Further, there may be a case where a plate 320a is removed in the situation shown in FIG. 9A (i.e., the situation shown in FIG. 10A). In this case, the determination unit 108 determines an image of the digital data 40b of the “second floor” associated with the height of the stacked plates 32 from the placement surface 30 (“H2” in the example illustrated in FIG. 10A) as the image to be displayed on the stacked plates 32, as illustrated in FIG. 10B. In addition, there may be a case where a plate 320b is removed in the situation shown in FIG. 10A (e.g., the situation shown in FIG. 11A). In this case, the determination unit 108 determines an image of the digital data 40c of the “first floor” associated with the height of the stacked plate 32 from the placement surface 30 (“H1” in the example illustrated in FIG. 11A) as the image to be displayed on the stacked plate 32, as illustrated in FIG. 11B.

### 2-1-5-2. Determination Example 2

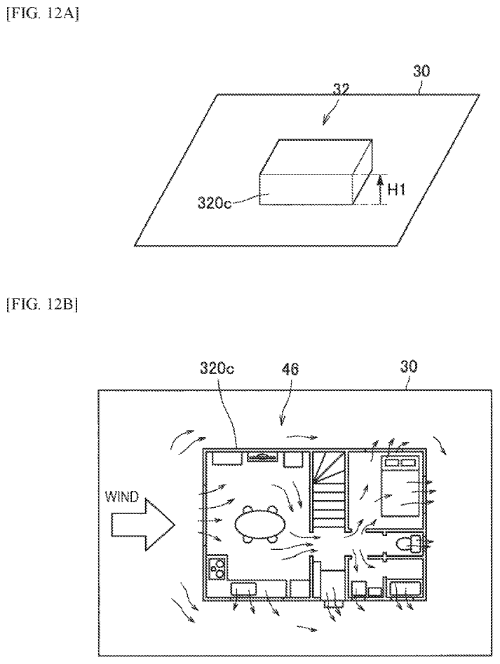

Further, the determination unit 108 determines, as the image to be displayed, an image (e.g., an image showing the result of the environmental simulation) of a type other than the cross section and the internal structure on the basis of the type of the application, settings of a mode (e.g., simulation mode), or the like. In one example, there may be a case where the stacked plate 32 is arranged on the placement surface 30 as illustrated in FIG. 12A and the digital data includes a plurality of hierarchies. In this case, the determination unit 108 may determine, as the image to be displayed, an image 46 showing a result of an air flow simulation from a particular wind direction inside the floor corresponding to the height of the stacked plate 32 from the placement surface 30, as illustrated in FIG. 12B. In addition, the determination unit 108 may determine, as the image to be displayed, an image showing the temperature distribution inside a floor corresponding to the height of the stacked plate 32 from the placement surface 30. In addition, the determination unit 108 may determine, as the image to be displayed, an image indicating the cooling effectiveness distribution inside a floor corresponding to the height of the stacked plate 32 from the placement surface 30. In addition, the determination unit 108 may determine, as the image to be displayed, a moving image indicating a flow line of a person on a floor corresponding to the height of the stacked plate 32 from the placement surface 30.

Furthermore, the determination unit 108 may determine, as the image to be displayed, an image on which two or more types of images among the above-described plural types of images are superimposed. In one example, the determination unit 108 may determine, as the image to be displayed, an image in which an image of the digital data 40 at the floor corresponding to the height of the stacked plate 32 from the placement surface 30 and an image indicating the temperature distribution inside the corresponding floor are superimposed.

### 2-1-6. Display Control Unit 110

### 2-1-6-1. Display of Image to be Displayed

The display control unit 110 controls display on the display unit 122. In one example, the display control unit 110 causes the display unit 122 to project the image to be displayed that is determined by the determination unit 108 on the surface closest to the display unit 122 among the surfaces included in the real object.

### 2-1-6-2. Display Depending on Top Surface of Real Object

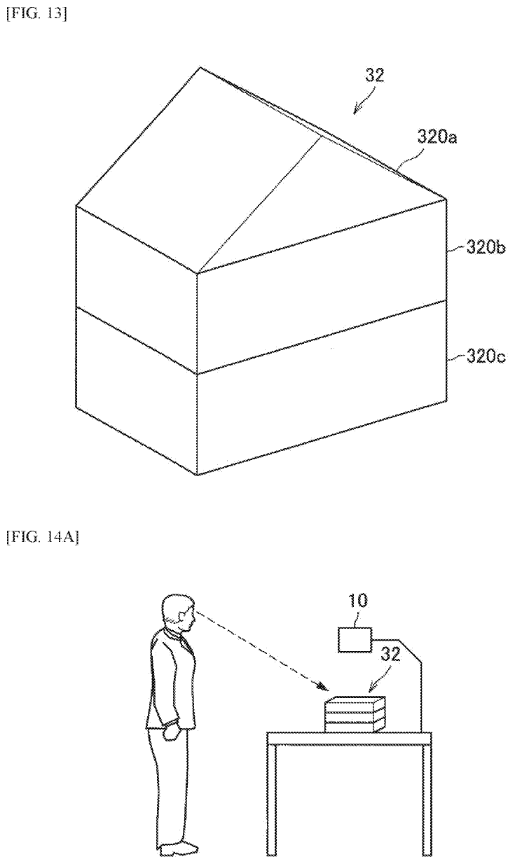

Moreover, in one example, as illustrated in FIG. 13, in the case where the top surface of the plate 320 closest to the display unit 122 is a slope, the image may be projected on the plate 320 so that the image extends along the slope. Thus, the display control unit 110 can also correct the image to be displayed depending on the shape of the plate on which the image is projected. In one example, the display control unit 110 converts and corrects the image to be displayed depending on the recognition result of the shape (e.g., an angle) of the top surface of the plate. Then, the display control unit 110 can cause the display unit 122 to project the corrected image on the top surface of the plate.

Moreover, the top surface of the plate is not limited to the slope. Even in the case where the top surface is a curved surface or the case where there is unevenness, the display controller 110 can correct the image to be displayed depending on a recognition result obtained by recognizing the shape of the top surface of the plate.

### 2-1-6-3. Display Depending on Positional Relationship Between Real Object and User

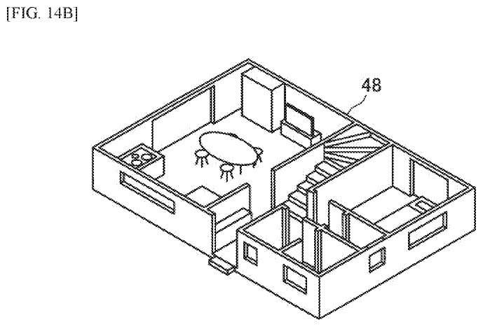

Further, the display control unit 110 can also correct the image to be displayed depending on the positional relationship between the stacked plate 32 and the user (or the positional relationship between the placement surface 30 and the user). In one example, the display control unit 110 can correct the image to be displayed so that the image becomes an image viewed from the direction of the user's face as illustrated in FIG. 14B. This correction is performed depending on a recognition result of the positional relationship between the stacked plate 32 and the position of the user's face as illustrated in FIG. 14A. In addition, the display control unit 110 may correct the image to be displayed so that the image to be displayed becomes an image viewed from the line-of-sight direction of the user, depending on the detection result of the line-of-sight direction of the user with respect to the stacked plate 32. Moreover, the positional relationship between the stacked plate 32 and the position of the user's face may be recognized by the recognition unit 104, for example, on the basis of the detection result of a camera (not shown) or a depth sensor (not shown) arranged in the environment where the user is located.

According to this correction example, the sense of depth can be expressed. This makes it possible for the user to experience the feeling of viewing more naturally the cross section, the internal structure, or the like corresponding to the image to be displayed.

### 2-1-6-4. Display Depending on Positional Relationship Between Light Source and Real Object

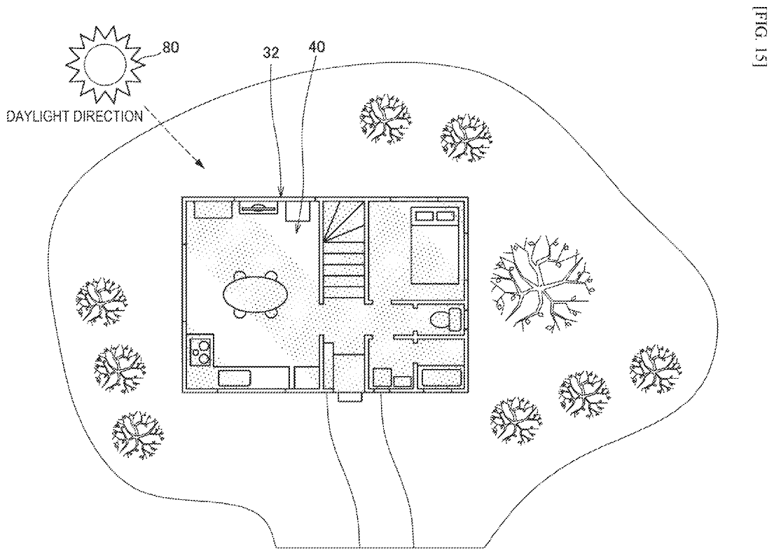

Further, the display control unit 110 can also correct the image to be displayed depending on the position of a virtual directional light source (e.g., the sun) arranged in the 3D scene. FIG. 15 is a diagram illustrating an example where an image 40 in which an image inside a floor corresponding to the height of the stacked plate 32 from the placement surface 30 and a simulation result of daylight inside the floor are superimposed is projected on the stacked plate 32. Moreover, in the example illustrated in FIG. 15, it is assumed that a virtual sun 80 is arranged in the 3D scene. In addition, an icon indicating the position of the virtual sun 80 may be projected on the placement surface 30.

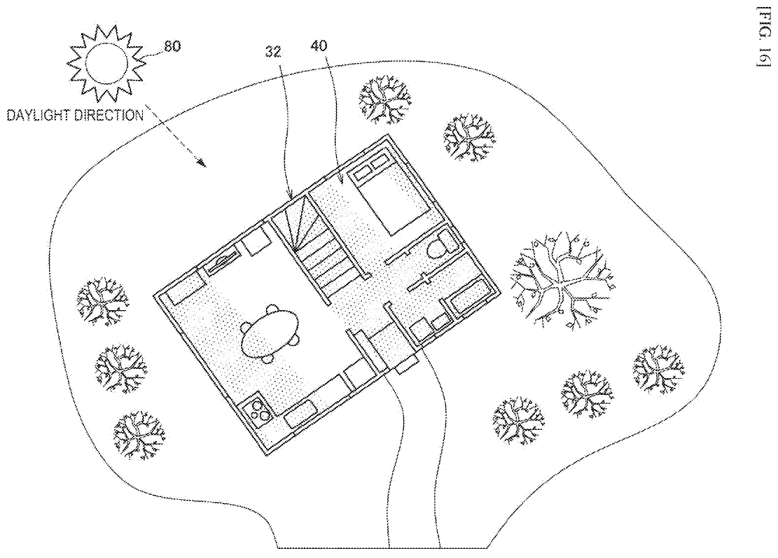

In one example, assume that the user changes the positional relationship between the virtual sun 80 and the stacked plate 32 by changing the position or orientation of the stacked plate 32 on the placement surface 30 such as a change from the state shown in FIG. 15 to the state shown in FIG. 16. In this case, the display control unit 110 can also correct the image to be displayed depending on the change in the positional relationship. In one example, the display control unit 110 corrects the image to be displayed so that the sunlight entering from a window of the architectural structure or shadow changes depending on the change in the positional relationship, and causes the display unit 122 to sequentially project the corrected images. According to this display example, the position of the stacked plate 32 or the position of an icon indicating the virtual sun 80 on the placement surface 30 can be moved at the discretion of the user, and thus it is possible to simulate the change in the sunlight entering inside the house or the shadow casted in the house according to a light direction.

### 2-1-6-5. Display of GUI

### Display Example 1

In addition, the display control unit 110 further allows a UI object such as an icon to be projected on the placement surface 30. Moreover, in the case where the same plural UI objects are displayed, unless otherwise processed, as a UI object projected on the real object is closer to the display unit 122, the object seems to be smaller size. This may make the operation of the UI object by the user difficult. In addition, the size of an object such as an icon is typically set depending on the thickness of a person's finger, thus the UI objects are preferably projected as if they have the same size even if the objects are projected on real objects having different heights.

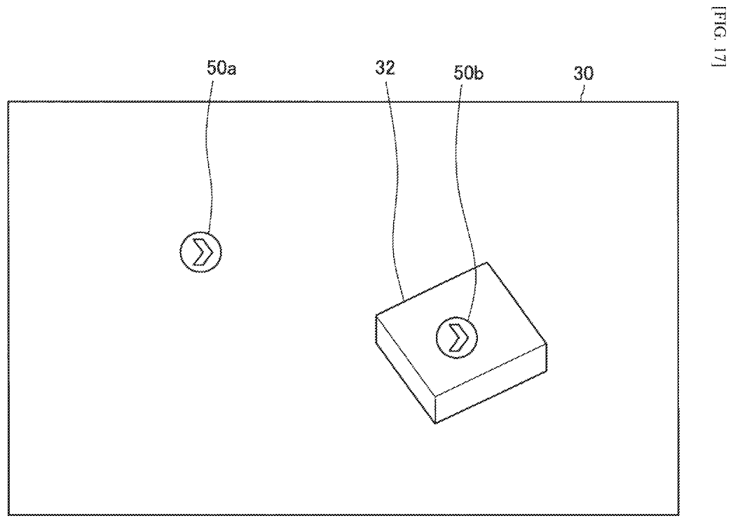

Thus, the display control unit 110 corrects preferably the size of individual UI objects 50 depending on a recognition result of the heights of the surfaces on which the individual UI objects 50 are projected from the placement surface 30 (or the distances between the surfaces on which the individual UI objects 50 are projected and the display unit 122). This may make it possible for the individual UI objects 50 to be projected with the same size even when the heights of the surfaces on which the same UI objects 50 are projected are different, as illustrated in FIG. 17.

### Display Example 2

In the case where the digital data is the volume data 42 as in the example illustrated in FIG. 5, an image corresponding to the height of the top surface of the plate 320 closest to the display unit 122 of the stacked plate 32 can be projected on the plate 320. In other words, in the case where one plate is removed from the stacked plates 32 or one plate is arranged on top of another plate, an image shifted by an interval corresponding to the one plate with respect to the height direction of the volume data 42 can be projected on the plate. Thus, the vertical movement of the plate by the user with hand allows an image, which is positioned in the middle of the range corresponding to one plate with respect to the height direction of the volume data 42, to be projected on the plate.

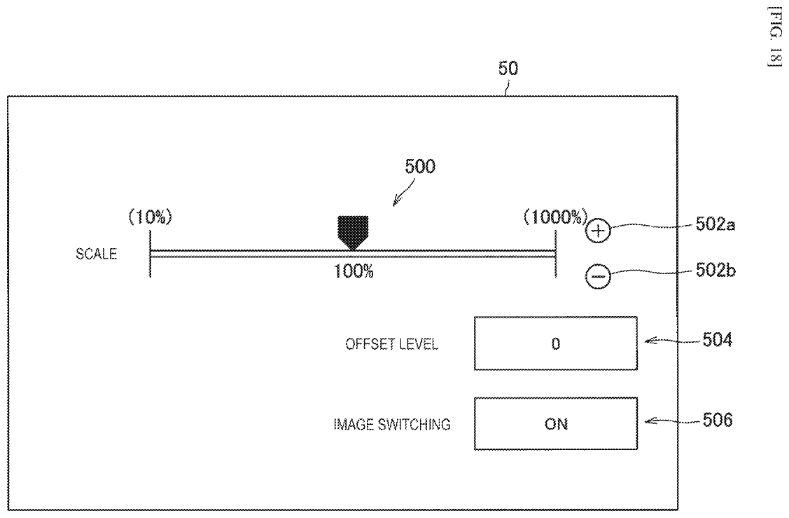

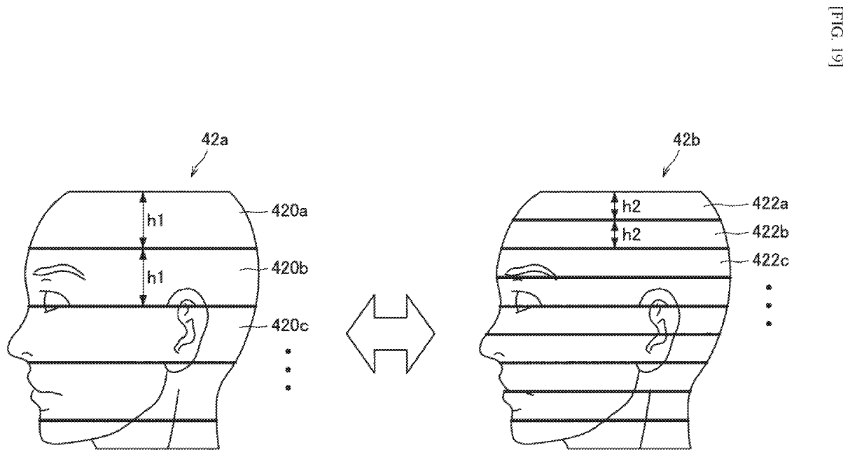

On the other hand, it is also preferable that an image with a height desired by the user with respect to the height direction of the volume data 42 can be projected more easily without being dependent on manual work. In one example, it is preferable that the scale of the range corresponding to one plate is variable with respect to the height direction of the volume data 42. Thus, the display control unit 110 can also cause a GUI 50 capable of changing the scale as illustrated in FIG. 18 to be projected on the placement surface 30. As illustrated in FIG. 18, the GUI 50 may include, for example, a scale change bar 500, an offset level input column 504, and an image switching setting column 506. Here, the scale change bar 500 may include a scale magnification button 502a and a scale reduction button 502b. The scale magnification button 502a and the scale reduction button 502b are buttons used to magnify and reduce the scale, respectively, in the range corresponding to one plate with respect to the height direction of the volume data 42. In one example, when the user presses the scale reduction button 502b, the range in the height direction of the volume data 42 corresponding to one plate 320 can be reduced from “h1” to “h2”, as illustrated in FIG. 19. This makes it possible for the user to check tomographic information at finer intervals with respect to the height direction of the volume data 42 by stacking or removing one plate.

Further, the offset level input column 504 is an input column used, by the user, to specify the amount of change of data corresponding to the plate 320 closest to the placement surface 30 with respect to the digital data corresponding to the stacked plate 32. In one example, in the case where the digital data includes a plurality of hierarchies, a value indicating the difference between the hierarchy desired by the user to be associated with the plate 320 closest to the placement surface 30 and the lowest hierarchy can be input in the offset level input column 504. In addition, in the case where the digital data is the volume data 42, the offset amount in the height direction of the volume data 42 within the range of data desired by the user to be associated with the plate 320 closest to the placement surface 30 can be input in the offset level input column 504.

Further, the image switching setting column 506 is an input column used to set whether to change the image projected on the stacked plate 32 in the case where the stacked plate 32 moves. In one example, when the image switching setting column 506 is set to “OFF”, the display control unit 110 controls display so that the image currently being projected on the top surface of the stacked plate 32 is not changed (maintained) even if the user holds the entire stacked plate 32 with hand. Moreover, the image switching setting column 506 can be set to “ON” (i.e., the image projected on the stacked plate 32 is changed each time the stacked plate 32 moves) in the initial state. Moreover, the GUI 50 is not limited to the example including all of the scale change bar 500, the offset level input column 504, and the image switching setting column 506, and may include only one or two of them.

### 2-1-7. Communication Unit 120

The communication unit 120 transmits and receives information to and from other devices. In one example, the communication unit 120 transmits a request to acquire the image to be displayed or the digital data to the server 20 under the control of the display control unit 110. In addition, the communication unit 120 receives the image or the digital data from the server 20.

### 2-1-8. Display Unit 122

The display unit 122 displays an image under the control of the display control unit 110. In one example, the display unit 122 projects an image in the forward direction of the display unit 122 under the control of the display control unit 110.

### 2-1-9. Storage Unit 126

The storage unit 126 stores various data and various kinds of software. In one example, the storage unit 126 temporarily stores information on the association performed by the association unit 106.

### 2-2. Application Example

The configuration according to embodiments have been described above. Next, an application example of an embodiment is described in the following items, “2-2-1. Application example 1” and “2-2-2. Application example 2”.

### 2-2-1. Application Example 1

Application example 1 is first described. The application example 1 assumes a scene where an architect and a client simulate a floor plan of a commissioned house, in one example. In addition, in the application example 1, in one example, images showing the respective floors of the house are projected on the top surface of the stacked plate 32, as illustrated in FIGS. 8A to 11B.

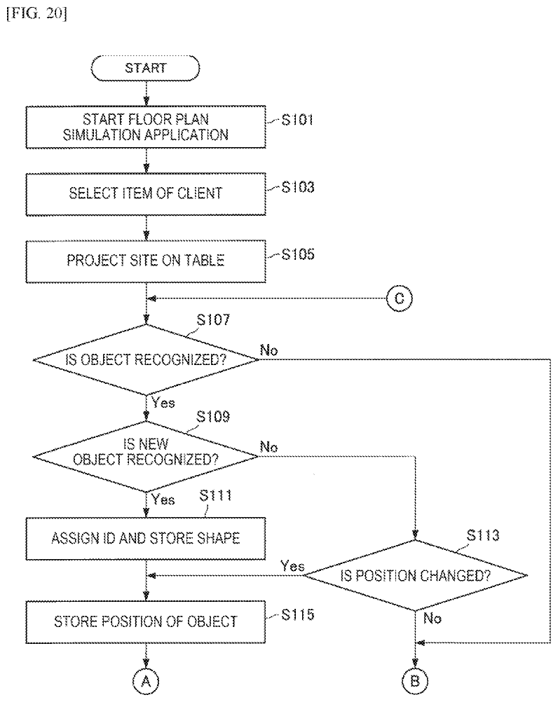

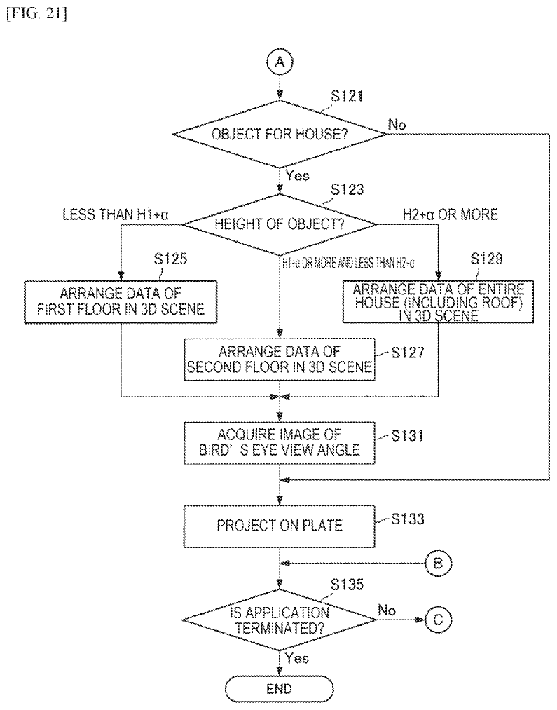

Here, the processing procedure according to the application example 1 is described with reference to FIGS. 20 and 21. As illustrated in FIG. 20, in one example, the user first selects a house floor plan simulation application among a plurality of applications stored in the storage unit 126, and starts the application (S101). Then, the user selects an item of the client to be targeted in the house floor plan simulation application (S103).

Then, the display unit 122 projects an image of the site corresponding to the item of the client selected in S103 on the placement surface 30 under the control of the display control unit 110 (S105).

Subsequently, the recognition unit 104 recognizes whether a real object is arranged on the placement surface 30 (S107). If it is recognized that a real object is not arranged on the placement surface 30 (No in S107), the control unit 100 performs the processing of S135 described later.

On the other hand, if it is recognized that a real object is arranged on the placement surface 30 (Yes in S107), the recognition unit 104 compares the recognition result of the shape of the arranged real object with, in one example, information on the shape of a known real object stored in the storage unit 126, and recognizes whether the arranged real object is a new real object on the basis of the comparison result (S109). If the arranged real object is recognized as a new real object (Yes in S109), the control unit 100 assigns an ID, used for identifying the real object, to the real object. Then, the control unit 100 associates the ID of the real object with the information on the shape of the real object recognized by the recognition unit 104 and stores it in the storage unit 126 (S111). Then, the control unit 100 performs the processing of S115 described later.

On the other hand, if it is recognized that the arranged real object is not a new real object (i.e., it is a known real object) (No in S109), the recognition unit 104 recognizes whether the position of the real object is changed from the immediately previous position (S113). If it is recognized that the position of the real object is not changed (No in S113), the control unit 100 performs the process of S135 described later.

On the other hand, if it is recognized that the position of the real object is changed (Yes in S113), the control unit 100 associates the ID of the real object with the position of the real object recognized in S113 and stores it in the storage unit 126 (S151).

Here, the processing procedure after SI 15 is described with reference to FIG. 21. As illustrated in FIG. 21, after S115, the recognition unit 104 recognizes whether the real object is a stacked plate for a house (S121). If it is recognized that the real object is not the stacked plate for a house (No in S121), the control unit 100 performs the processing of S133 described later.

On the other hand, if it is recognized that the real object is the stacked plate for a house (Yes in S121), the recognition unit 104 recognizes the height (from the placement surface 30) of the real object (S123). If it is recognized that the height of the real object is less than “H1+a (a predetermined threshold)”, the determination unit 108 determines an image of the “first floor” of the house as the image to be displayed. Then, the display control unit 110 arranges data of the “first floor” of the house in the 3D scene (S125).

On the other hand, if it is recognized that the height of the real object is “H1+a” or more and less than “H2+a”, the determination unit 108 determines an image of the “second floor” of the house as the image to be displayed. Then, the display control unit 110 arranges data of the “second floor” of the house in the 3D scene (S127).

On the other hand, if it is recognized that the height of the real object is “H2+a” or more, the determination unit 108 determines an image of the “roof” of the house as the image to be displayed. Then, the display control unit 110 arranges the data of the entire house (including the roof) of the corresponding house in the 3D scene (S129).

Then, after S125, S127, or S129, the display control unit 110 causes a virtual camera tool to capture the data of the house arranged in the 3D scene at the same camera angle as in S105, and then acquires the captured image (S131). Then, the display unit 122 projects the image acquired in S131 on the stacked plate under the control of the display control unit 110 (S133).

Subsequently, if the user performs an operation to terminate the house floor plan simulation application (Yes in S135), the processing procedure ends. On the other hand, if the user does not perform the operation to terminate the house floor plan simulation application (No in S135), the control unit 100 again performs the processing of S107 and subsequent steps.

### Modified Example

Moreover, the above description is made for the example in which the display control unit 110 arranges the data of the floor corresponding to the image to be displayed in the 3D scene in S125 to S129, but the present disclosure is not limited to this example. As a modified example, the modeling data of the house can be fixed in the 3D scene. In S125 to S129, the display control unit 110 may make data of a floor above the floor corresponding to the image to be displayed out of the modeling data transparent.

### 2-2-2. Application Example 2

Next, application example 2 is described. The application example 2 assumes that the image to be displayed includes a UI object capable of being moved on the basis of the recognition result of the movement of the user's hand.

### 2-2-2-1. Display Control Unit 110

The display control unit 110 according to the application example 2 can change the display position of the UI object included in the image on the basis of a recognition result of the movement of the hand of the user approaching or touching the surface of the plate on which the image to be displayed is projected. In one example, the display control unit 110 changes the display position of the UI object corresponding to the position of the user's hand when it is recognized that the user's hand approaches or touches the surface among the plurality of UI objects included in the image on the basis of the recognition result of the movement of the hand of the user.

Further, the display control unit 110 can also cause the display unit 122 to display a representation indicating the existence of the UI object in the image while superimposing it on the image on the basis of the positional relationship between the surface and the user's hand.

### Specific Example

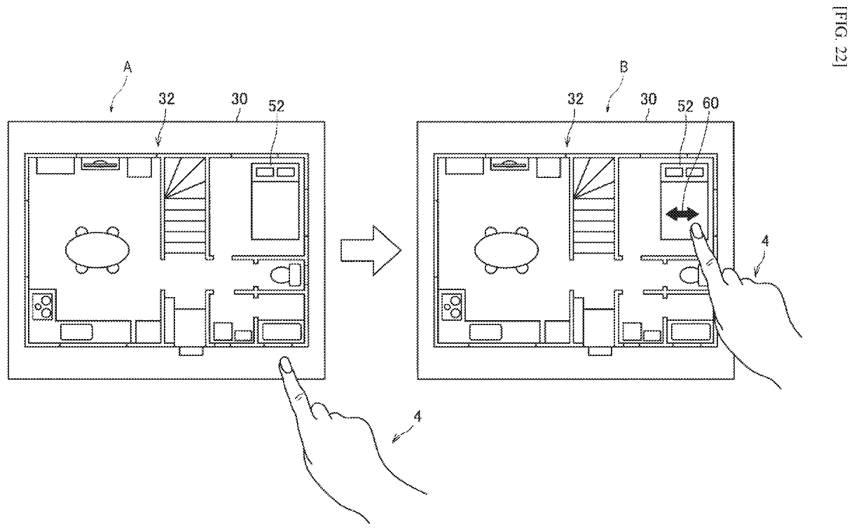

Here, the function mentioned above is described in more detail with reference to FIG. 22 to FIG. 25B. Moreover, as shown in the portion A of FIG. 22, an image of the interior of the floor corresponding to the height of the stacked plate 32 is projected on the top surface of the stacked plate 32 (arranged on the placement surface 30) and the image includes a UI object 52 of the furniture. In this case, as shown in the portion B of FIG. 22, in the case where the user brings the hand, which functions as an operation tool, close to the display position of the projected UI object 52 to perform a proximity operation, the display control unit 110 may cause the display unit 122 to display an icon 60 on the UI object 52. The icon 60 has the shape of an arrow indicating the existence of the UI object 52.

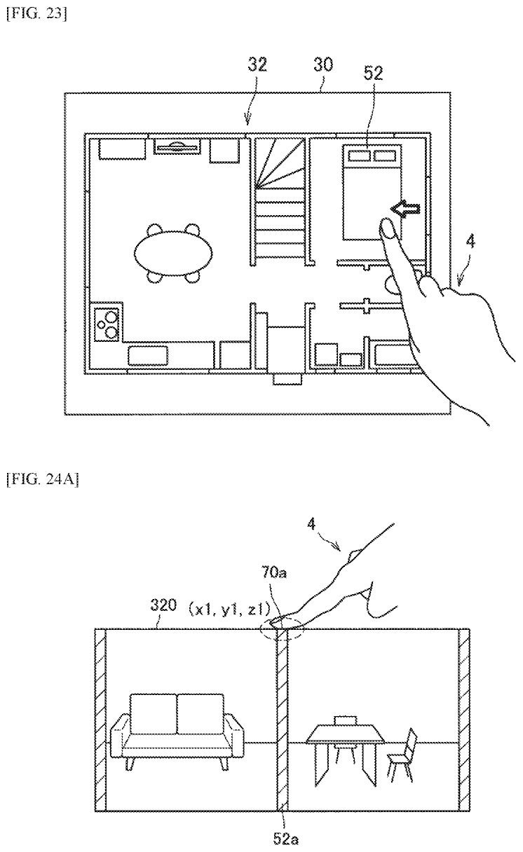

Then, in the case where the user's hand touches (or approaches) the display position (or the vicinity of the display position) of the UI object 52 and the drag operation is recognized, the control unit 110 moves the display position of the UI object 52 depending on the recognized drag operation as illustrated in FIG. 23. Moreover, in this event, the display control unit 110 may cause the display unit 122 to further project the initial display position of the UI object 52, for example, using a contour line or the like.

Moreover, there may be a case where it is recognized that a plurality of fingers approach the stacked plate 32 at the same time. In this case, the display control unit 110 can cause the icon 60 indicating the existence of the UI object 52 to be displayed or cause the display position of the UI object 52 to be moved, on the basis of the recognition result of the movement of each of the plurality of fingers.

According to this display example, the movement of the user's hand on the plate makes it possible for the user to change freely the position of furniture and a wall projected on the plate and to check the changed layout.

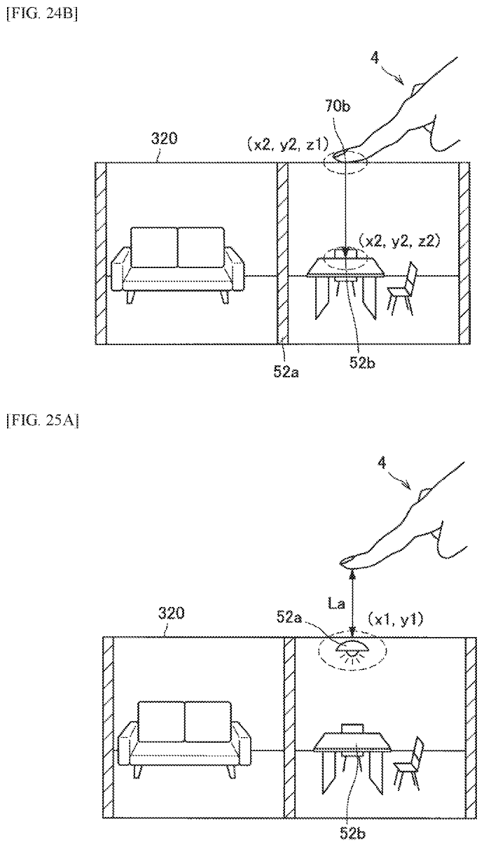

Moreover, as illustrated in FIGS. 24A and 24B, the UI object 52 to be selected by the user may be specified on the basis of the coordinates of the touch position of the user operation tool in contact with the top surface of the plate 320 on which the image is projected during a touch operation. In one example, in the case where the user touches a position 70a on the plate 320 as illustrated in FIG. 24A, it may be determined that the user selects a UI object 52a of the wall corresponding to the XY coordinates of the position 70a. In addition, in the case where the user touches a position 70b on the plate 320 as illustrated in FIG. 24B, it may be determined that the user select a UI object 52b of the table corresponding to the XY-coordinates of the position 70b.

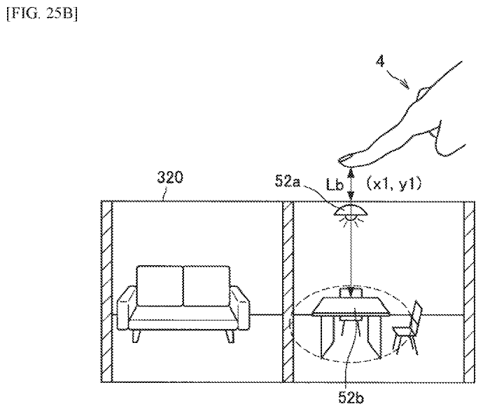

Further, the plurality of UI objects 52 may be associated with the XY-coordinates of the top surface of one plate 320 as illustrated in FIGS. 25A and 25B. Then, in this case, in one example, the UI object 52 to be selected by the user can be specified on the basis of the recognition result of the distance between the top surface of the plate 320 and the user's hand (e.g., a finger). In the examples shown in FIGS. 25A and 25B, the user's finger is located away from the plate 320, and the XY-coordinates on the plate 320 corresponding to the finger are associated with a UI object 52a of the light fixture and a UI object 52b of the table. In this case, in the case where the distance between the user's finger and the plate 320 is relatively large as illustrated in FIG. 25A, it may be determined that the user selects the UI object 52 (the UI object 52a of the light fixture) having a larger Z-coordinate value (e.g., in the virtual space). Further, in the case where the distance between the user's finger and the plate 320 is relatively small as illustrated in FIG. 25B, it may be determined that the user selects the UI object 52 (the UI object 52b of the table) having a smaller Z-coordinate value.

### 2-2-2-2. Processing Procedure

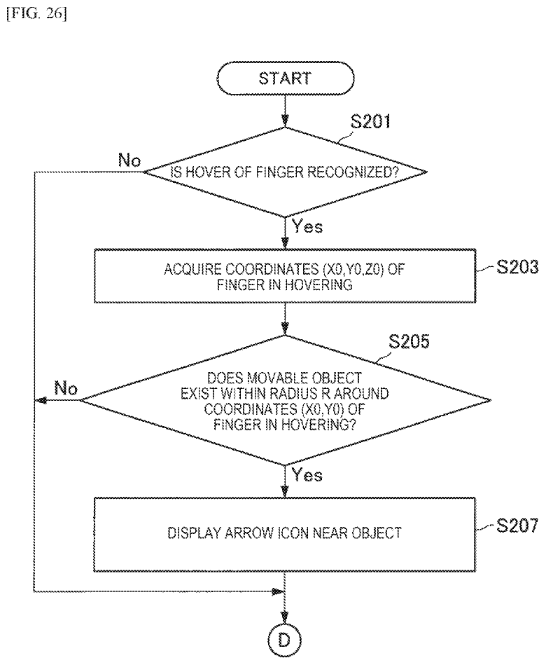

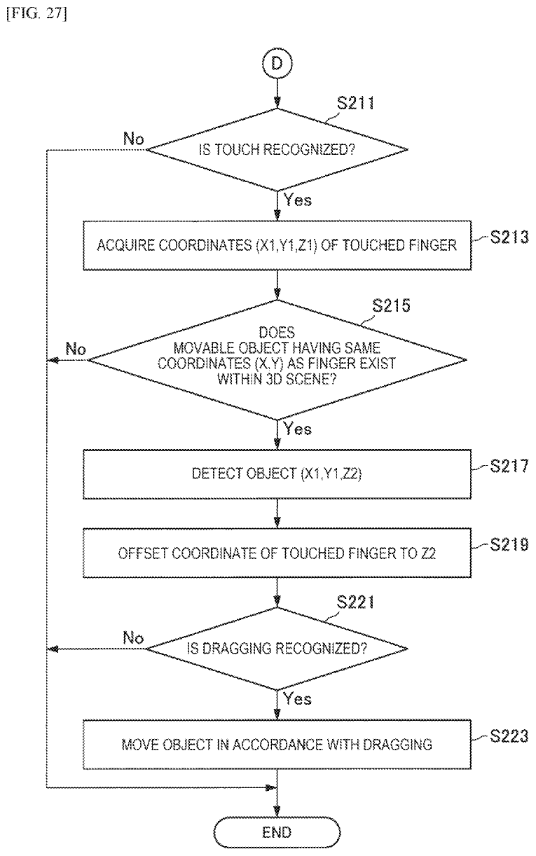

Here, the processing procedure according to application example 2 is described with reference to FIGS. 26 and 27. As illustrated in FIG. 26, first, the recognition unit 104 recognizes whether hover is performed over the stacked plate (S201). Here, the hover may be, for example, an operation in which the user moves the finger or hand at a position slightly away from the real object without touching the real object.

If the hover over the stacked plate is not recognized (No in S201), the recognition unit 104 performs the processing of S211 described later. On the other hand, if the hover over the stacked plate is recognized (Yes in S201), the recognition unit 104 specifies coordinates (X0,Y0,Z0) of the finger in hovering (S203).

Then, the display control unit 110 decides whether a UI object exists within the radius R around the coordinates specified in S203 in the image projected on the stacked plate (S205). If a UI object does not exist within the radius R (No in S205), the recognition unit 104 performs the processing of S211 described later.

On the other hand, if a UI object exists within the radius R (Yes in S205), the display unit 122 displays an arrow icon near the UI object under the control of the display control unit 110 (S207).

Here, the processing procedure after S207 is described with reference to FIG. 27.

As illustrated in FIG. 27, after S207, the recognition unit 104 recognizes whether the stacked plate is touched (S211). If it is recognized that no touch is made (No in S211), the processing procedure ends.

On the other hand, if it is recognized that a touch is made (Yes in S211), the recognition unit 104 specifies coordinates (X1,Y1,Z1) of the position touched on the stacked plate (S213).

Subsequently, the display control unit 110 decides whether a UI object whose coordinates (X,Y) are the same as the coordinates specified in S213 exists in the 3D scene (S215). If the UI object does not exist (No in S215), the processing procedure ends.

On the other hand, if the UI object exists (Yes in S215), the display control unit 110 specifies the coordinates of the UI object (S217). Subsequently, the display control unit 110 offsets the Z-coordinate in the coordinates specified in S213 to coincide with the Z-coordinate of the object specified in S217 (S219).

Then, the recognition unit 104 recognizes whether dragging is performed on the stacked plate (S221). If it is recognized that dragging is not performed (No in S221), the processing procedure ends.

On the other hand, if it is recognized that dragging is performed (Yes in S221), the display control unit 110 moves the display position of the UI object specified in S217 in accordance with the recognized dragging (S223). Then, the processing procedure ends.

Moreover, the processing procedure according to the application example 2 may be combined with the processing procedure according to the application example 1. In one example, the processing procedure according to the application example 2 may be executed between steps S133 and S135 according to the application example 1.

### 2-3. Effect

### 2-3-1. Effect 1

As described above, the information processing device 10 according to an embodiment determines the image to be displayed on the basis of the recognition result of the positional relationship between the surface included in the real object and the reference position and the digital data corresponding to the real object.

Thus, the information processing device 10 can determine the positional relationship between the real object and the reference position, and can determine the image to be displayed adaptively to the real object. In one example, the user can perform interactive change of an image projected on the plate by stacking or removing the plate on the placement surface 30.

### 2-3-2. Effect 2

Further, the information processing device 10 can project an image of a cross section depending on the height of the stacked plate on the stacked plate with respect to the digital data corresponding to the stacked plate. Thus, the user can check easily and intuitively the interior of the architectural structure and the internal structure of the product, for example, by stacking or removing the plate.

### 2-3-3. Effect 3

Further, according to an embodiment, an image can be projected on the surface of a real object. Thus, the user can easily know the actual scale as compared with the case of viewing only the 3D CG image.

### 2-34. Effect 4

Further, an embodiment can be implemented by using a general-purpose and primitive plate. Thus, the system can be constructed inexpensively.

### 2-3-5. Effect 5

Further, according to an embodiment, a plurality of users can view an image projected on the stacked plate simultaneously and can operate it at the same time.

In one example, in the field of architectural design or product design, a plurality of persons concerned can jointly examine the details of the design by viewing an image of the interior of the architectural structure or the internal structure of the product being planned.

### 2-4. Application Example

In the above description, an example has been described in which one or more plates are arranged on top of each other and the image to be displayed is determined on the basis of the total height of the stacked plates. However, the present disclosure is not limited to such an example. An application example of an embodiment will be described. As described later, according to this application example, individual plates are arranged in parallel, and the display unit 122 can be caused to display a plurality of images to be displayed on the individual plates. In the following, the repeated description will be omitted.

### 2-4-1. Association Unit 106

The association unit 106 according to the present application example associates individual plates with digital data depending on information relating to the individual plates. In one example, in the case where the digital data includes data of a plurality of hierarchies, the association unit 106 associates each individual plate with one of the data of the plurality of hierarchies depending on the information relating to the individual plates. Here, an example of the information relating to the plate includes at least one of the height of the plate, the shape of the plate, the color of the plate (e.g., the color of the outer peripheral portion of the plate), information included in a marker such as a two-dimensional barcode (e.g., invisible marker) printed on the plate, the character (e.g., “1F”), image, or ruled line pattern printed on the plate, material of the plate, and information on the area in which the plate is placed on the placement surface 30. In addition, the association unit 106 associates the individual plates (or the stacked hierarchies) with the digital data depending on the time series information of the arrangement or stacking of the individual plates (e.g., information indicating that a plate B, a plate A, and a plate C are arranged in this order).

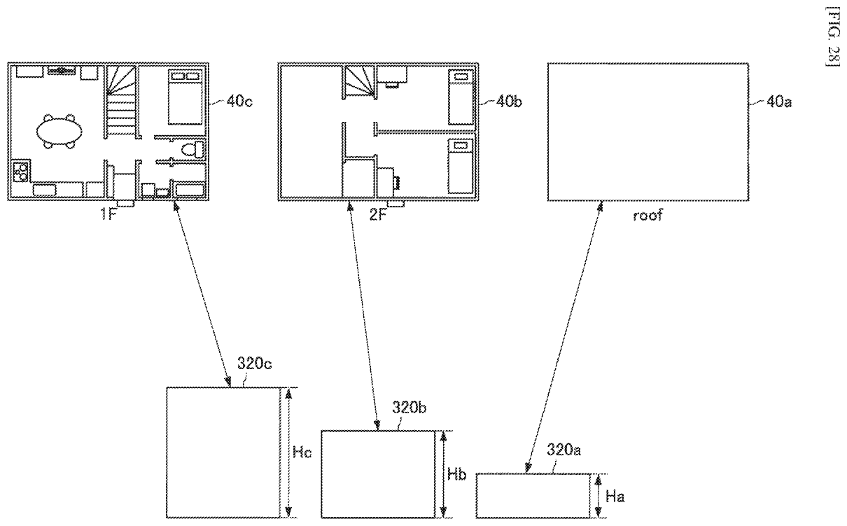

Here, the function described above is described in more detail with reference to FIG. 28. FIG. 28 is a diagram illustrating an example in which data of each of a plurality of hierarchies and individual plates are associated with each other depending on the height of individual plates. As illustrated in FIG. 28, the association unit 106 associates a plate 320c whose height is within a predetermined threshold range from “Hc” with the digital data 40c of the “first floor” of a building. In addition, the association unit 106 associates a plate 320b whose height is within a predetermined threshold range from “Hb” with the digital data 40b of the “second floor” of the building. In addition, the association unit 106 associates a plate 320a whose height is within a predetermined threshold range from “Ha” with the digital data 40a of the “roof” of the building.

### 2-4-2. Determination Unit 108

The determination unit 108 according to the present application example determines an image to be displayed for each individual plate on the basis of the information relating to individual plates recognized by the recognition unit 104 and the digital data corresponding to the individual plates.

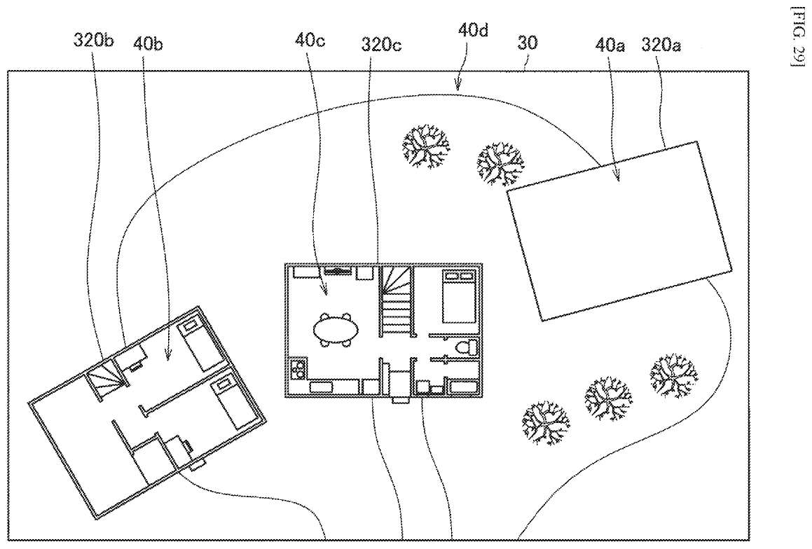

In one example, in the case where the digital data includes data of a plurality of hierarchies, the determination unit 108 first specifies the digital data corresponding to the plate with respect to individual plates located within the range detected by the sensor unit 124 on the basis of the recognition result of the height of the plate, as illustrated in FIG. 29. Then, the determination unit 108 determines the image to be displayed for each individual plate on the basis of the specified digital data.

### 2-4-3. Display Control Unit 110

The display control unit 110 according to the present application example causes the display unit 122 to project an image to be displayed, which is determined for the plate by the determination unit 108, on the surface of individual plates recognized by the recognition unit 104.

As described above, according to the present application example, the individual plates can be arranged in parallel on the placement surface 30. Then, the information processing device 10 projects the images to be displayed, which are determined depending on the information relating to the individual plates, on the individual plates. Thus, it is possible to develop and display a plurality of cross sections on the placement surface 30. In one example, the user can check the floor plan of each floor of a building in a list.

### 3. HARDWARE CONFIGURATION

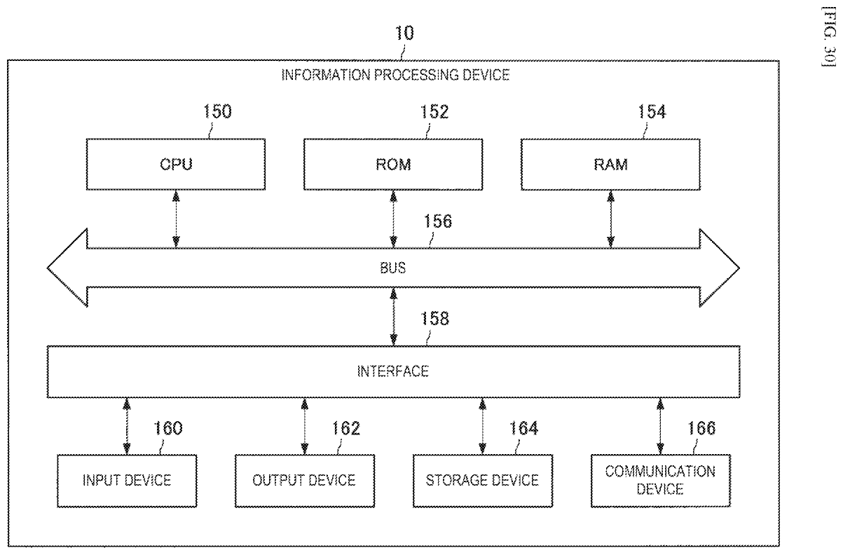

Next, a hardware configuration of the information processing device 10 according to an embodiment is described with reference to FIG. 30. As illustrated in FIG. 30, the information processing device 10 is configured to include a CPU 150, a read only memory (ROM) 152, a RAM 154, a bus 156, an interface 158, an input device 160, an output device 162, a storage device 164, and a communication device 166.

The CPU 150 functions as an arithmetic processing unit and a control unit, and controls the overall operation in the information processing device 10 in accordance with various programs. In addition, the CPU 150 implements the functions of the control unit 100 in the information processing device 10. Moreover, the CPU 150 is composed of a processor such as a microprocessor.

The ROM 152 stores programs and control data such as operation parameters, which are used by the CPU 150.

The RAM 154 temporarily stores, for example, programs or the like executed by the CPU 150.

The bus 156 is composed of a CPU bus or the like. The bus 156 connects the CPU 150, the ROM 152, and the RAM 154 to each other.

The interface 158 connects the bus 156 with the input device 160, the output device 162, the storage device 164, and the communication device 166.

The input device 160 includes, in one example, an input unit and an input control circuit. The input unit allows the user to enter information, and an example of the input unit includes a touch panel, a button, a switch, a dial, a lever, and a microphone. The input control circuit generates an input signal on the basis of the input by the user and outputs it to the CPU 150.

The output device 162 includes a display device such as a projector, a liquid crystal display device, an organic light emitting diode (OLED) device, or a lamp. In addition, the output device 162 includes an audio output device such as a speaker.

The storage device 164 is a device for data storage that functions as the storage unit 126. The storage device 164 includes, in one example, a storage medium, a recording device that records data in the storage medium, a reading device that reads data from the storage medium, and a deletion device that deletes data recorded in the storage medium.

The communication device 166 is a communication interface composed of, in one example, a communication device or the like for connecting to the communication network 22 or the like. In addition, the communication device 166 may be a wireless LAN compatible communication device, a long-term evolution (LTE) compatible communication device, or a wire communication device that performs wired communication. The communication device 166 functions as the communication unit 120.

### 4. MODIFIED EXAMPLE

It should be understood by those skilled in the art that various modifications, combinations, sub-combinations and alterations may occur depending on design requirements and other factors insofar as they are within the scope of the appended claims or the equivalents thereof.

### 4-1. Modified Example 1

In one example, although an embodiment describes the example in which the scale of the range corresponding to one plate with respect to the height direction of the volume data 42 is changed by the operation on the GUI 50 as illustrated in FIG. 18, the present disclosure is not limited such an example. In one example, the information processing device 10 can change the scale on the basis of a recognition result of a gesture, a recognition result of the voice command, information input by using a predetermined input device, or the like.

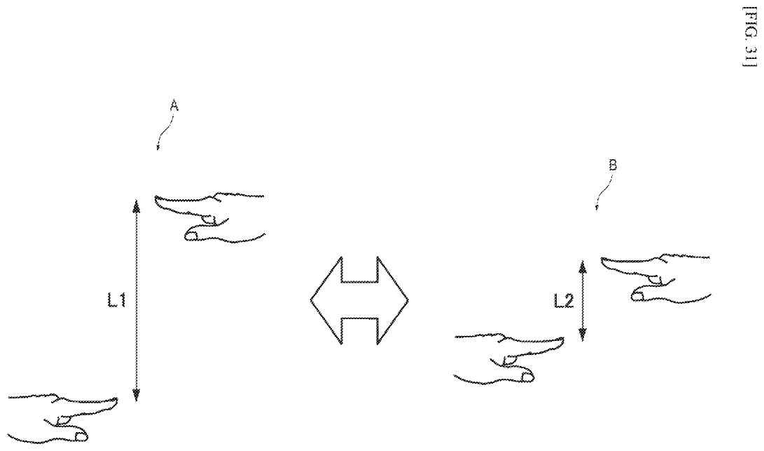

In one example, the information processing device 10 may change the scale of the range corresponding to one plate with respect to the height direction of the volume data 42 on the basis of a recognition result of the gesture for changing the distance between two fingers in the air as illustrated in FIG. 31. In one example, in the case where it is recognized that both hands (or one hand) are moved from the posture of both hands as illustrated in the portion A of FIG. 31 to the posture of both hands as illustrated in the portion B of FIG. 31, the information processing apparatus 10 may reduce the range in the height direction of the volume data 42 corresponding to one plate as illustrated in FIG. 19.

### 4-2. Modified Example 2

Further, in one example, although an example in which only one stacked plate 32 is arranged on the placement surface 30 is illustrated in FIG. 9A and other drawings, the present disclosure is not limited thereto, and a plurality of stacked plates 32 may be arranged on the placement surface 30. In this case, the information processing device 10 may use different types of digital data projected on the stacked plate 32 for each of the plurality of stacked plates 32. In one example, the information processing device 10 may project “layout of building A” on the stacked plate 32a and “layout of building B” on the stacked plate 32b. In addition, the information processing device 10 may project “layout image of the house” on the stacked plate 32a and “image of result of air flow simulation (of the house)” on the stacked plate 32b.

### 4-3. Modified Example 3

Further, although an embodiment describes an example in which the display unit 122 projects an image on the placement surface 30, the present disclosure is not limited to such an example. In one example, the display unit 122 is a glasses type display, and the information processing device 10 may cause the display unit 122 to display an image to be displayed, which is determined depending on the real object detected by the sensor unit 124, in association with the real object. In this case, the display unit 122 may be a see-through (transparent) type display or an opaque (non-transparent) type display. In the latter case, a camera attached to the display unit 122 can capture an image in front of the display unit 122. Then, the information processing device 10 may superimpose the image to be displayed on the image captured by the camera and may cause display unit 122 to display it.

### 4-4. Modified Example 4

Further, the configuration of the information processing system according to an embodiment is not limited to the example illustrated in FIG. 1. In one example, although only one information processing device 10 is shown in FIG. 1, this configuration is not limited to this example, and a plurality of computers may cooperatively operate to implement the above-described functions of the information processing device 10.

### 4-5. Modified Example 5

Further, the configuration of the information processing device 10 is not limited to the example illustrated in FIG. 3. In one example, one or more of the display unit 122 and the sensor unit 124 may be included in another device that can communicate with the information processing device 10 instead of being included in the information processing device 10. In this case, the information processing device 10 may be other types of devices than the projector device as illustrated in FIG. 1. In one example, the information processing device 10 may be a general-purpose personal computer (PC), a tablet terminal, a game machine, a mobile phone including smartphone, a portable music player, a robot, and a wearable device including a head-mounted display (HMD), augmented reality (AR) glasses, or smart watch.

Further, in the case where the server 20 includes each of the components included in the control unit 100 described above, the information processing device according to an embodiment of the present disclosure may be the server 20.

### 4-6. Modified Example 6

Further, the steps in the processing procedure of each application example described above are not necessarily to be executed in the described order. In one example, the steps may be executed in the order changed as appropriate. In addition, the steps may be executed in parallel or individually in part, instead of being executed in chronological order. In addition, some of the steps described may be omitted, or an additional step may be added.

Further, according to an embodiment, a computer program for causing hardware such as the CPU 150, the ROM 152, and the RAM 154 to execute a function equivalent to each configuration of the information processing device 10 according to an embodiment described above can be provided. In addition, a recording medium on which the computer program is recorded is provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing apparatus including:

circuitry configured to
detect a three-dimensional (3D) object and a distance from a surface of the 3D object to a reference position, wherein the surface of the 3D object is located between the reference position and a sensor that is used to detect the distance,
determine an image corresponding to the detected 3D object and the detected distance from the surface of the 3D object to the reference position, and
control a displaying of the determined image upon the surface of the 3D object.
(2)

The information processing apparatus according to (1), wherein the displaying of the determined image includes projecting the determined image onto the surface of the 3D object.

(3)

The information processing apparatus according to (1) or (2), wherein the surface of the 3D object is a top surface, and the projecting of the determined image onto the top surface is performed by a projector located above the top surface.

(4)

The information processing apparatus according to any of (1) to (3), wherein the surface of the 3D object is a side surface, and the projecting of the determined image onto the side surface is performed by a projector located to a side of the side surface.

(5)

The information processing apparatus according to any of (1) to (4), wherein the determined image corresponds to a vertical or horizontal cross sectional layer of the 3D object based on the detected distance from the surface of the 3D object to the reference position.

(6)

The information processing apparatus according to any of (1) to (5), wherein when the detected 3D object is a model of a building, the determined image corresponds to a floor of the building based on the detected distance from the surface of the model of the building to the reference position.

(7)

The information processing apparatus according to any of (1) to (6), wherein the sensor used to detect the distance from the surface of the 3D object to the reference position includes one or more of a stereo camera and a depth sensor.

(8)

The information processing apparatus according to any of (1) to (7), wherein the displaying of the determined image includes displaying the determined image in a plane parallel to the surface of the 3D object by a head-mounted display (HMD).

(9)

The information processing apparatus according to any of (1) to (8), wherein the displaying of the determined image is further controlled according to a user operation.

(10)

The information processing apparatus according to any of (1) to (9), wherein the user operation includes a proximity operation or a touch operation of an operation tool of the user.

(11)

The information processing apparatus according to any of (1) to (10), wherein the user operation includes moving a displayed virtual object within the determined image.

(12)

The information processing apparatus according to any of (1) to (11), wherein the user operation includes changing environmental data related to the 3D object.

(13)

The information processing apparatus according to any of (1) to (12), wherein the environmental data includes one or more of a light direction and a wind direction.

(14)

An image processing method, performed via at least one processor, the method including:

detecting a three-dimensional (3D) object and a distance from a surface of the 3D object to a reference position, wherein the surface of the 3D object is located between the reference position and a sensor that is used to detect the distance;
determining an image corresponding to the detected 3D object and the detected distance from the surface of the 3D object to the reference position; and
controlling a displaying of the determined image upon the surface of the 3D object.
(15)

The information processing method according to (14), wherein the displaying of the determined image includes projecting the determined image onto the surface of the 3D object.

(16)

The information processing method according to (14) or (15), wherein the surface of the 3D object is a top surface, and the projecting of the determined image onto the top surface is performed by a projector located above the top surface.

(17)

The information processing method according to any of (14) to (16), wherein the surface of the 3D object is a side surface, and the projecting of the determined image onto the side surface is performed by a projector located to a side of the side surface.

(18)

The information processing method according to any of (14) to (17), wherein the determined image corresponds to a vertical or horizontal cross sectional layer of the 3D object based on the detected distance from the surface of the 3D object to the reference position.

(19)

The information processing method according to any of (14) to (18), wherein when the detected 3D object is a model of a building, the determined image corresponds to a floor of the building based on the detected distance from the surface of the model of the building to the reference position.

(20)

The information processing method according to any of (14) to (19), wherein the sensor that is used to detect the distance from the surface of the 3D object to the reference position includes one or more of a stereo camera and a depth sensor.

(21)

The information processing method according to any of (14) to (20), wherein the displaying of the determined image includes displaying the determined image in a plane parallel to the surface of the 3D object by a head-mounted display (HMD).

(22)

The information processing method according to any of (14) to (21), wherein the displaying of the determined image is further controlled according to a user operation.

(23)

A non-transitory computer-readable storage medium having embodied thereon a program, which when executed by a computer, causes the computer to execute a method, the method including:

detecting a three-dimensional (3D) object and a distance from a surface of the 3D object to a reference position, wherein the surface of the 3D object is located between the reference position and a sensor that is used to detect the distance;
determining an image corresponding to the detected 3D object and the detected distance from the surface of the 3D object to the reference position; and
controlling a displaying of the determined image upon the surface of the 3D object.

Furthermore, the present technology may also be further configured as below.

(1)

An information processing system including:

an acquisition unit configured to acquire a recognition result obtained by recognizing a positional relationship between a first surface included in a real object and a reference position; and
a determination unit configured to determine an image to be displayed in association with the first surface on the basis of the recognition result of the positional relationship and digital data corresponding to the real object.
(2)

The information processing system according to (1),

in which the positional relationship is a distance between the first surface and the reference position.
(3)

The information processing system according to (2),

in which the first surface is a surface having a minimum or maximum distance to the reference position among surfaces included in the real object.
(4)

The information processing system according to any one of (1) to (3),

in which a plurality of the real objects are arranged within a predetermined space, and
the determination unit determines the image on the basis of a positional relationship between the first surface of a first real object having a minimum or maximum distance to the reference position among the plurality of real objects and the reference position.
(5)

The information processing system according to (4),

in which, in a case where a change of the real object having the minimum or maximum distance to the reference position among the plurality of real objects from the first real object to a second real object is recognized, the determination unit determines an image to be displayed in association with the first surface of the second real object on the basis of a positional relationship between the second real object and the reference position.
(6)

The information processing system according to (4) or (5),

in which the plurality of real objects are arranged side by side in one direction.
(7)

The information processing system according to any one of (1) to (6),

in which the determination unit determines the image further on the basis of a recognition result obtained by recognizing a shape of the real object.
(8)

The information processing system according to any one of (1) to (7),

in which the digital data includes data of a plurality of hierarchies, and
the determination unit determines the image on the basis of data of a hierarchy corresponding to the positional relationship among the data of the plurality of hierarchies.
(9)

The information processing system according to any one of (1) to (7),

in which the digital data includes data of a plurality of hierarchies, and
the determination unit determines the image on the basis of data of a hierarchy corresponding to the real object among the data of the plurality of hierarchies.
(10)

The information processing system according to any one of (1) to (7),

in which the digital data is three-dimensional data, and
the determination unit determines an image indicating a cross section depending on the positional relationship of the digital data as the image to be displayed in association with the first surface.
(11)

The information processing system according to (10),

in which a plurality of the real objects are arranged within a predetermined space, and
a range of data corresponding to each of the plurality of real objects in the digital data is different from each other.
(12)

The information processing system according to (11),

in which the plurality of real objects include a first real object, and
a range of data corresponding to the first real object among the digital data is changed on the basis of specification by a user.
(13)

The information processing system according to (12), further including:

a display control unit configured to cause a display unit to display an operation image used to change the range of the data corresponding to the first real object among the digital data.
(14)

The information processing system according to any one of (1) to (12), further including:

a display control unit configured to cause a display unit to display an image determined by the determination unit in association with the first surface.
(15)

The information processing system according to (14),

in which the display unit is a projection unit, and
the display control unit causes the projection unit to project the image determined by the determination unit on the first surface.
(16)

The information processing system according to (14) or (15),

in which the image includes a virtual object, and
the display control unit changes a display position of the virtual object in the image on the basis of a recognition result obtained by recognizing a movement of a user's hand approaching or touching the first surface.
(17)

The information processing system according to (16),

in which the image includes a plurality of the virtual objects, and
the display control unit changes a display position of a virtual object corresponding to a position of the user's hand recognized as touching or approaching the first surface among the plurality of virtual objects on the basis of the recognition result of the movement of the user's hand.
(18)

The information processing system according to (16) or (17),

in which the display control unit causes the display unit to display a representation indicating existence of the virtual object in the image while superimposing the representation on the image on the basis of a positional relationship between the first surface and the user's hand.
(19)

A method of information processing, including:

acquiring a recognition result obtained by recognizing a positional relationship between a first surface included in a real object and a reference position; and
determining, by a processor, an image to be displayed in association with the first surface on the basis of the recognition result of the positional relationship and digital data corresponding to the real object.
(20)

A program for causing a computer to function as:

an acquisition unit configured to acquire a recognition result obtained by recognizing a positional relationship between a first surface included in a real object and a reference position; and
a determination unit configured to determine an image to be displayed in association with the first surface on the basis of the recognition result of the positional relationship and digital data corresponding to the real object.

### REFERENCE SIGNS LIST

10 information processing device
20 server
22 communication network
100 control unit
102 detection result acquisition unit
104 recognition unit
106 association unit
108 determination unit
110 display control unit
120 communication unit
122 display unit
124 sensor unit
126 storage unit

1. An information processing apparatus comprising:
circuitry configured to
detect a three-dimensional (3D) object and a distance from a surface of the 3D object to a reference position, wherein the surface of the 3D object is located between the reference position and a sensor that is used to detect the distance,
determine an image corresponding to the detected 3D object and the detected distance from the surface of the 3D object to the reference position, and
control a displaying of the determined image upon the surface of the 3D object.

2. The information processing apparatus according to claim 1, wherein the displaying of the determined image comprises projecting the determined image onto the surface of the 3D object.

3. The information processing apparatus according to claim 2, wherein the surface of the 3D object is a top surface, and the projecting of the determined image onto the top surface is performed by a projector located above the top surface.

4. The information processing apparatus according to claim 2, wherein the surface of the 3D object is a side surface, and the projecting of the determined image onto the side surface is performed by a projector located to a side of the side surface.

5. The information processing apparatus according to claim 1, wherein the determined image corresponds to a vertical or horizontal cross sectional layer of the 3D object based on the detected distance from the surface of the 3D object to the reference position.

6. The information processing apparatus according to claim 1, wherein when the detected 3D object is a model of a building, the determined image corresponds to a floor of the building based on the detected distance from the surface of the model of the building to the reference position.

7. The information processing apparatus according to claim 1, wherein the sensor used to detect the distance from the surface of the 3D object to the reference position comprises one or more of a stereo camera and a depth sensor.

8. The information processing apparatus according to claim 1, wherein the displaying of the determined image comprises displaying the determined image in a plane parallel to the surface of the 3D object by a head-mounted display (HMD).

9. The information processing apparatus according to claim 1, wherein the displaying of the determined image is further controlled according to a user operation.

10. The information processing apparatus according to claim 9, wherein the user operation comprises a proximity operation or a touch operation of an operation tool of the user.

11. The information processing apparatus according to claim 9, wherein the user operation comprises moving a displayed virtual object within the determined image.

12. The information processing apparatus according to claim 9, wherein the user operation comprises changing environmental data related to the 3D object.

13. The information processing apparatus according to claim 12, wherein the environmental data comprises one or more of a light direction and a wind direction.

14. An image processing method, performed via at least one processor, the method comprising:
detecting a three-dimensional (3D) object and a distance from a surface of the 3D object to a reference position, wherein the surface of the 3D object is located between the reference position and a sensor that is used to detect the distance;
determining an image corresponding to the detected 3D object and the detected distance from the surface of the 3D object to the reference position; and
controlling a displaying of the determined image upon the surface of the 3D object.

15. The information processing method according to claim 14, wherein the displaying of the determined image comprises projecting the determined image onto the surface of the 3D object.

16. The information processing method according to claim 15, wherein the surface of the 3D object is a top surface, and the projecting of the determined image onto the top surface is performed by a projector located above the top surface.

17. The information processing method according to claim 15, wherein the surface of the 3D object is a side surface, and the projecting of the determined image onto the side surface is performed by a projector located to a side of the side surface.

18. The information processing method according to claim 14, wherein the determined image corresponds to a vertical or horizontal cross sectional layer of the 3D object based on the detected distance from the surface of the 3D object to the reference position.

19. The information processing method according to claim 14, wherein when the detected 3D object is a model of a building, the determined image corresponds to a floor of the building based on the detected distance from the surface of the model of the building to the reference position.

20. The information processing method according to claim 14, wherein the sensor that is used to detect the distance from the surface of the 3D object to the reference position comprises one or more of a stereo camera and a depth sensor.

21. The information processing method according to claim 14, wherein the displaying of the determined image comprises displaying the determined image in a plane parallel to the surface of the 3D object by a head-mounted display (HMD).

22. The information processing method according to claim 14, wherein the displaying of the determined image is further controlled according to a user operation.

23. A non-transitory computer-readable storage medium having embodied thereon a program, which when executed by a computer, causes the computer to execute a method, the method comprising:
detecting a three-dimensional (3D) object and a distance from a surface of the 3D object to a reference position, wherein the surface of the 3D object is located between the reference position and a sensor that is used to detect the distance;
determining an image corresponding to the detected 3D object and the detected distance from the surface of the 3D object to the reference position; and
controlling a displaying of the determined image upon the surface of the 3D object.
